(19) United States
(12) Patent Application Publication
(10) Pub. No.: US 2026/0061744 A1
(43) Pub. Date: Mar. 5, 2026

(54) LIQUID EJECTION HEAD

(71) Applicant: CANON KABUSHIKI KAISHA, Tokyo (JP)

(72) Inventors: TAKASHI KATO, Kanagawa (JP); YOSHIYUKI NAKAGAWA, Kanagawa (JP)

(21) Appl. No.: 19/309,912

(22) Filed: Aug. 26, 2025

(30) Foreign Application Priority Data
Aug. 27, 2024 (JP) 2024-145433
May 20, 2025 (JP) 2025-083793

(51) Int. Cl. B41J 2/14; B41J 2/045; B41J 2/175; B41J 2/19

(52) U.S. Cl. CPC B41J 2/1404; B41J 2/0458; B41J 2/1433; B41J 2/17563; B41J 2/19; B41J 2202/07; B41J 2202/12

(57) ABSTRACT

A liquid ejection head including: individual ejection units that include ejection ports, pressure chambers, first energy generation elements that are provided in the pressure chambers and generate heat energy, and second energy generation elements that are provided in individual flow paths and generate heat energy; and a common flow path that supplies a liquid to the individual flow paths, a direction in which the ejection ports are aligned perpendicularly intersecting an extending direction of the individual flow paths, the liquid ejection head being provided with a structure in which a flow resistance between the first energy generation elements and the second energy generation elements is increased is used.

### BACKGROUND

### Field of the Technology

The present disclosure relates to a liquid ejection head.

### Description of the Related Art

A circulation-type liquid ejection device that circulates ink for the purpose of discharging air bubbles in a flow path and curbing an increase in viscosity of the ink in the vicinity of an ejection port in a liquid ejection head (hereinafter, also referred to as a “head”) is known. As a method of circulating ink, a scheme using a pressure difference (hereinafter, also referred to as a “differential pressure scheme”) is well known. In the scheme, a pressure adjustment mechanism or the like is used to increase the pressure on a side on which ink is supplied to an ejection port (IN side) as compared with a side on which the ink is collected (OUT side) to thereby cause the ink to flow from the IN side to the OUT side. At this time, it is necessary to return the ink that has flowed to the OUT side to the IN side in order to circulate the ink, and a pump is required as a mechanism therefor. There is also a configuration in which a liquid is circuited inside a liquid ejection head by providing a pump inside the liquid ejection head in a case of circulating the liquid between the liquid ejection head and a recording device main body or the like, by providing the pump outside the head of the main body. However, such a differential pressure-type circulation method requires a pressure adjustment mechanism and a mechanism such as a pump, and the sizes of the recording device main body and the head are likely to increase.

Thus, ink circulation methods other than the differential pressure scheme have been studied. Specifically, a mechanism of circulating ink in a circulation path by providing a circulation flow path that communicates with an ejection port, disposing an energy generation element (hereinafter, also referred to as a “flowing energy generation element”) different from an energy generation element (hereinafter, also referred to as an “ejection energy generation element”) for ejecting the ink to the circulation flow path, and driving the flowing energy generation element is known.

Japanese Patent Application Laid-Open No. 2020-104312 discloses a configuration in which a circulation flow path extending to intersect an ejection port array of a plurality of aligned ejection ports is provided and a flowing energy generation element is included in the circulation path.

### SUMMARY

The present disclosure provides a liquid ejection head comprising:
individual ejection units that include ejection ports that eject a liquid, pressure chambers that communicate with the ejection ports, first energy generation elements that are provided in the pressure chambers and generate heat energy for ejecting the liquid from the ejection ports, individual flow paths that communicate with the pressure chambers, and second energy generation elements that are provided in the individual flow paths and generate heat energy; and
a common flow path configured to supply the liquid to the individual flow paths of the plurality of individual ejection units, wherein
the plurality of ejection ports included in the plurality of individual ejection units form an ejection port array,
the first energy generation elements and the second energy generation elements are disposed in a direction intersecting the ejection port array in the individual flow paths of the individual ejection units,
the individual flow paths extend in a direction intersecting the ejection port array such that both end portions thereof are located with the ejection port array interposed therebetween, and
the individual flow paths are provided with resistance structures that increase a flow resistance between the first energy generation elements and the second energy generation elements.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are overall views of a device using a liquid ejection head.

FIGS. 2A to 2D are an overall view of the liquid ejection head and overall views of liquid ejection chips.

FIGS. 3A to 3D are schematic views in the vicinity of an ejection port of the liquid ejection head.

FIGS. 4A to 4C are schematic views in the vicinity of the ejection port of the liquid ejection head.

FIGS. 5A to 5D are schematic views in the vicinity of the ejection port of the liquid ejection head.

FIGS. 6A to 6F are schematic views in the vicinity of an ejection port of a liquid ejection head according to a first embodiment.

FIGS. 7A to 7C are overall schematic views in the vicinity of the ejection port of the liquid ejection head according to the first embodiment.

FIGS. 8A to 8C are circulation flow amount graphs in some examples of the first embodiment.

FIGS. 9A to 9D are schematic views in the vicinity of an ejection port of a liquid ejection head according to a second embodiment.

FIGS. 10A to 10F are schematic views in the vicinity of an ejection port of a liquid ejection head according to a third embodiment.

FIGS. 11A to 11C are schematic views in the vicinity of an ejection port of a liquid ejection head according to a fourth embodiment.

FIGS. 12A and 12B are schematic views in the vicinity of an ejection port of a liquid ejection head according to a fifth embodiment.

FIG. 13 is a circuit configuration diagram according to the first embodiment.

### DESCRIPTION OF THE EMBODIMENTS

Hereinafter, preferred embodiments of the present disclosure will be described in detail with reference to the accompanying drawings. Note that the following embodiments do not limit the present disclosed matters and all combinations of features described in the present embodiments are not necessarily essential for the solution of the present disclosure. Note that the same components will be denoted by the same reference signs. In the following description, basic configurations of the present disclosure will be first described, and characteristic parts of the present disclosure will then be described.

According to the inventor's studies, it is necessary to extend a circulation flow path to optimize circulation efficiency of a flowing energy generation element to maximize the circulation flow amount in the related art, which increases the size of a substrate including the energy generation element and thus the sizes of a head and a recording device. On the other hand, in a case where the circulation flow path is simply shortened, circulation efficiency of the flowing energy generation element is degraded, which leads to a problem that the circulation flow amount decreases. Thus, a liquid ejection head capable of exhibiting desired circulation efficiency and maintaining a circulation flow amount with a shortened circulation flow path and a reduced substrate size is required.

### Liquid Ejection Device

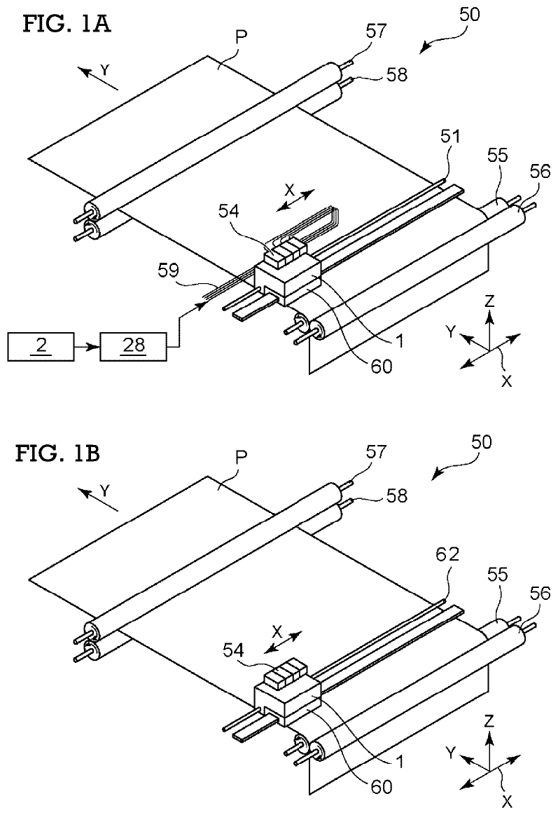

First, an overview configuration of a liquid ejection device 50 according to the present embodiment will be described. FIGS. 1A and 1B are enlarged views of a liquid ejection head 1 of the liquid ejection device 50 and the vicinity thereof, where FIGS. 1A and 1B are perspective views schematically illustrating a liquid ejection device using a liquid ejection head. The liquid ejection device 50 illustrated in FIGS. 1A and 1B is a liquid ejection device (a serial-type liquid ejection device) in the form in which the liquid ejection device forms images by ejecting a liquid onto a recording medium P by a liquid ejection head that performs scanning in a direction intersecting a transport direction of the recording medium P. The present disclosure can be applied not only to the serial-type liquid ejection device but also a page wide-type liquid ejection device that records images by ejecting a liquid onto a recording medium transported in a transport direction using a line head (page wide-type head) that is elongated in a page width direction of the recording medium. Note that the liquid ejection head according to the present embodiment can eject four kinds of inks of black (K), cyan (C), magenta (M), and yellow (Y) and can record full-color images with these inks. The inks that can be ejected from the liquid ejection head are not limited to the aforementioned four kinds of inks. The present disclosure can also be applied to liquid ejection heads to eject other kinds of inks. In other words, the kinds and the number of inks to be ejected from the liquid ejection head are not limited.

In the serial-type liquid ejection device 50, the liquid ejection head 1 is mounted on a carriage 60. The carriage 60 reciprocates in a main scanning direction (X direction) along a guide shaft 62. A recording medium is transported in a sub-scanning direction (Y direction) intersecting (perpendicularly intersecting in the case of this example) by transport rollers (transport mechanisms) 55, 56, 57, and 58. Note that a Z direction indicates a vertical direction and intersects (perpendicularly intersects, in the case of this example) an X-Y plane defined by the X direction and the Y direction in each drawing referred to herein below.

FIG. 1A illustrates a configuration in which a main ink tank 2 as a liquid storage unit is provided outside the liquid ejection head. The liquid (ink) stored in the ink tank 2 is supplied to a sub-ink tank 54 or the like on the side of the liquid ejection head 1 via an ink supply tube (liquid communication path) 59 or the like by a drive force of an external pump 28. On the other hand, FIG. 1B illustrates a configuration in which an ink tank 54 is included immediately above the liquid ejection head 1 (without including the main ink tank 2 as a liquid storage unit outside the liquid ejection head). At this time, the liquid ejection head 1 may be provided integrally with the ink tank 54 or may be configured to be detachable from/attachable to the carriage 60, or the liquid ejection head 1 may be provided integrally with the carriage 60 with only the ink tank 54 configured to be detachable/attachable. The following description will be given using the configuration in FIG. 1A as a representative example.

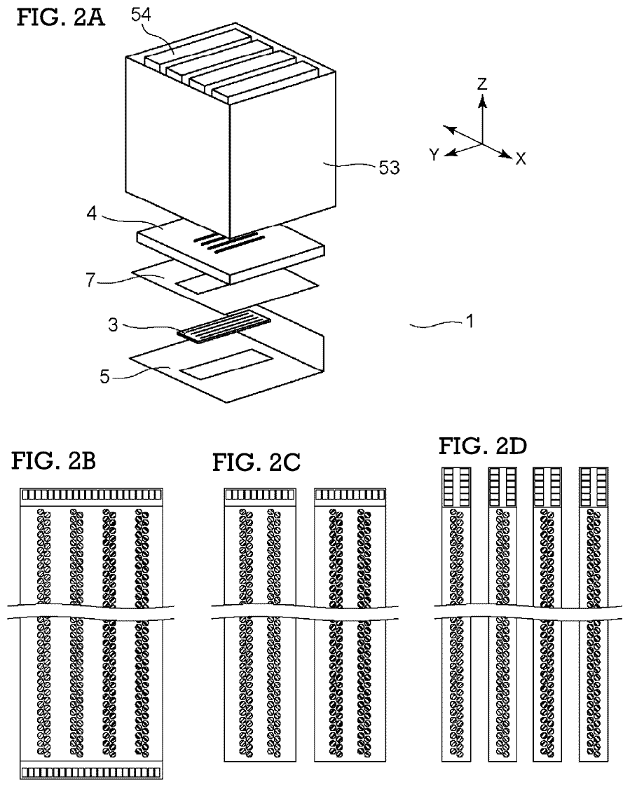

The liquid ejection head 1 is configured to include individual ejection units, which will be described later (see FIGS. 2A to 2D). Although a specific configuration will be described later, the individual ejection units are provided with ejection ports to eject a liquid, pressure chambers that communicate with the ejection ports, first energy generation elements (ejection energy generation elements) that are provided in the pressure chambers and generate energy to eject the liquid from the ejection ports, individual flow paths that communicate with the pressure chambers, and second energy generation elements (flowing energy generation elements) that are provided in the individual flow paths. The liquid ejection head 1 includes the plurality of individual ejection units and includes a supply flow path to supply the liquid to the individual flow paths in the individual ejection units.

Ejection of the liquid may become unstable due to evaporation of volatile components such as moisture from the ejection ports, accompanying concentration of solid content near the ejection ports, and the like when the liquid ejection head is used, and various kinds of arrangement have been made to prevent such cases. For example, it is possible to provide a cap member (not illustrated) capable of covering an ejection port surface, in which the ejection ports are formed, in the liquid ejection head at a position spaced apart from a transport path of the recording medium in the X direction in the liquid ejection device. The cap member is used for the purpose of covering the ejection port surface of the liquid ejection head, preventing the ejection ports from being dried, and protecting the ejection ports when a recording operation is not being performed. Furthermore, it is also possible to provide an ink suctioning mechanism (not illustrated), and in that case, the cap member is used for an ink suctioning operation and the like from the ejection ports. It is possible to refresh the ink near the ejection ports and maintain the level of obtained image quality by performing the ink suctioning operation. Moreover, a method of performing ejection that is called preliminary ejection (preliminary discharge) when the recording operation is not being performed to discard concentrated ink and preliminarily ejecting (paper surface preliminary ejection/intra-page preliminary ejection) the ink at a position and in an amount such that the ink is unnoticeable in terms of image quality on the recording medium even during the recording operation are also known. Although these methods greatly contribute to an improvement in image quality, a part of the ink is discarded to refresh the ejection ports, and minimizing the amount of ink to be discarded is required.

To solve such a problem, it is possible to curb drying of the ejection ports and concentration of the ink near the ejection ports while reducing the amount of ink to be discarded by providing the second energy generation elements (flowing energy generation elements) in the individual flow paths and circulating the ink in the flow paths. More specifically, the numbers of times of preliminary ejection and suctioning and recovery can be minimized. Furthermore, if it is possible to minimize the numbers of times of preliminary ejection and the like, this leads to improvements in throughput and yield.

It is not necessary to provide the second energy generation elements (flowing energy generation elements) in all the individual ejection units of the liquid ejection head. It is possible to obtain the aforementioned effect if the second energy generation elements are provided in some of the individual ejection units as compared with a case where second energy generation elements are not provided in any of the individual ejection units.

Also, the liquid ejection head illustrated in FIG. 1A may be configured such that all portions corresponding to the four kinds of inks include the second energy generation elements or may be configured such that only a portion corresponding to one kind of ink includes the second energy generation element. In other words, the liquid ejection head may be configured to circulate only at least one kind of ink instead of circulating all the four kinds of inks.

### Basic Configuration of Liquid Ejection Head

FIG. 2A is an exploded perspective view of the liquid ejection head according to the present embodiment. As illustrated in FIGS. 2A to 2D, the liquid ejection head is configured to include a sub-ink tank 54 that temporarily stores the ink in the head and a liquid ejection chip 3 to eject the ink supplied from the sub-ink tank 54 to a recording medium P. The liquid ejection head according to the present embodiment is fixedly supported on a carriage by a positioning mechanism and an electrical contact which are provided in the carriage of the liquid ejection device and are not illustrated. The liquid ejection head ejects the ink while moving in the main scanning direction (X direction) illustrated in FIGS. 1A and 1B along with the carriage to thereby perform recording on the recording medium P.

The external pump 28 connected to the ink tank 2 serving as an ink supply source is provided with an ink supply tube 59 (see FIG. 1A). A liquid connector, which is not illustrated, is provided at a distal end of the ink supply tube. When the liquid ejection head 1 is mounted on the liquid ejection device 50, the liquid connector provided at the distal end of the ink supply tube 59 is connected, in a liquid tight manner, to a liquid connector insertion port which is provided in a head casing of the liquid ejection head 1 and serves as a liquid introduction port. In this manner, an ink supply path reaching the liquid ejection head 1 from the ink tank 2 via the external pump 28 is formed. Since four kinds of inks are used in the present embodiment, four sets each including the ink tank 2, the external pump 28, the ink supply tube 59, and the sub-ink tank 54 are provided to correspond to the inks, and the four ink supply paths corresponding to the inks are independently formed. In this manner, the liquid ejection device according to the present embodiment includes an ink supply system to which the ink is supplied from the ink tanks 2 provided outside the liquid ejection head 1. Note that the liquid ejection device according to the present embodiment does not include an ink collection system to collect the ink from the inside of the liquid ejection head into the ink tank. Therefore, although the liquid ejection head is provided with the liquid connector insertion port to establish connection to the ink supply tube of the ink tank, the liquid ejection head is not provided with a connector insertion port to establish connection to a tube to collect the ink from the liquid ejection head into the ink tank. Note that the liquid connector insertion port is provided for each ink.

FIGS. 2B, 2C, and 2D are overall views of liquid ejection chips configuring the liquid ejection head. FIG. 2B illustrates a configuration of one chip for four colors, FIG. 2C illustrates a configuration of one chip for two colors, and FIG. 2D illustrates a configuration of one chip for one color. Each liquid ejection chip is provided with ejection ports and a pad used for electrical implementation. FIG. 2A illustrates a chip configuration of FIG. 2B.

FIG. 2B illustrates a first embodiment in which one chip for four colors is configured. The four colors are, for example, black, cyan, magenta, and yellow, and each color configure each array which is aligned in the Y direction. The adjacent ejection ports in the arrays are disposed with deviation in the X direction and are disposed at equal intervals in the Y direction. Here, the ejection ports in the arrays may be disposed in one array in the Y direction without any deviation in the X direction. Alternatively, only the ejection ports for black may be disposed in two arrays, and a total of five arrays may be provided for the four colors.

FIG. 2C illustrates a second embodiment in which one chip is configured for two colors and two chips are used. When the two chips are implemented in the liquid ejection head, the two chips may be implemented in one liquid ejection head, or two liquid ejection heads each including one chip implemented therein may be prepared.

FIG. 2D illustrates a third embodiment in which one chip is configured for one color and four chips are used. Similarly to FIG. 2C, four chips may be implemented in one liquid ejection head, or four liquid ejection heads each including one chip implemented therein may be prepared.

Also, it is not necessary for all the chips to have the same length in a case where a plurality of chips are prepared in a split manner as in FIGS. 2C and 2D. Also, there can be other various combinations of the numbers of colors with respect to the chips, and the same applies to cases in which the total number of colors is greater than four.

### Components of Circulation Unit

### Straight Type

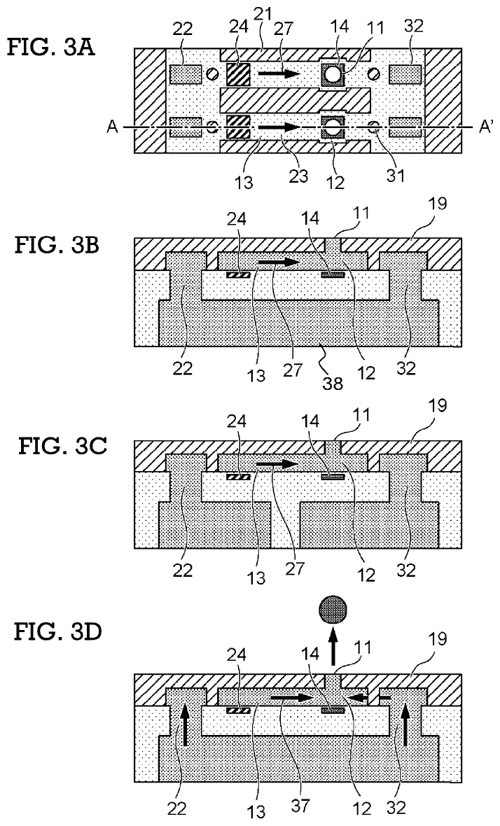

FIGS. 3A to 3D are schematic views for explaining the vicinity of ejection ports of a straight-type liquid ejection head. The “straight type” in the present specification means that the individual flow paths where the first energy generation elements (ejection energy generation elements) and the second energy generation elements (flowing energy generation elements) are disposed have a straight shape extending in a direction intersecting the ejection port arrays (the perpendicularly intersecting direction in FIGS. 3A to 3D) such that both end portions thereof are located on both sides with the ejection port array interposed therebetween. In other words, the first energy generation elements and the second energy generation elements are disposed in the direction intersecting the ejection port arrays in the individual flow paths of the individual ejection units.

FIG. 3A is a plan view seen in a direction in which liquid droplets are ejected from the ejection ports. FIG. 3B is a sectional view along A-A′ in FIG. 3A. FIG. 3C is another sectional view along A-A′ in FIG. 3A. FIG. 3D is a diagram for explaining flowing-in of the ink in a case where the first energy generation elements are driven.

In FIGS. 3A to 3C, pressure chambers 12 partitioned by partitioning walls 21 and corresponding to the ejection ports 11, respectively, and the individual flow paths 23 to cause the ink to flow through the pressure chambers 12 are formed between a substrate 18 and an orifice plate 19. There are ink menisci at the ejection ports 11, and ejection port interfaces as interfaces between the ink and the atmospheric air are formed.

The substrate 18 includes first energy generation elements 14 that generate energy to eject the ink inside the pressure chambers. In this example, thermoelectric conversion elements are used. The first energy generation elements 14 are located closer to a second supply opening 32 than a first supply opening 22 along with the ejection ports 11 and the pressure chambers 12. It is possible to eject the ink from the ejection ports 11 using foaming energy by driving, through heat generation, the first energy generation elements 14 and causing the ink inside the pressure chambers 12 to foam.

Also, the substrate 18 includes second energy generation elements 24 that generate energy to cause circulation flows 27 indicated by the arrows in the ink inside the individual flow paths. In this example, electrothermal conversion elements are used. Therefore, the second energy generation elements 24 will also be referred to as circulation heaters 24.

Furthermore, the substrate 18 is provided with openings to supply a liquid from a common flow path to the individual flow paths. The openings may be a plurality of openings (individual supply openings) as in FIG. 3A or may be a supply groove as one big opening. The second energy generation elements 24 are located closer to the first supply opening 22 than the second supply opening 32.

The individual flow paths 23 extend in a second direction intersecting (perpendicularly intersecting in this example) a direction (first direction) of the arrays in which the ejection ports are aligned. The individual flow paths 23 include the pressure chambers 12, inlet (upstream)-side connection flow paths 13 in FIG. 3B that communicate with end portions of the pressure chamber 12 on one side, and outlet (downstream)-side flow paths in FIG. 3B that communicate with end portions of the pressure chambers 12 on the other side. The individual flow paths 23 communicate with the first supply opening 22 and the second supply opening 32 penetrating through the substrate 18 at one ends on the upstream side and the other ends on the downstream side. Therefore, the connection flow paths 13 are located on the side closer to the second energy generation elements than the ejection port array. Both end portions of the individual flow paths 23 are located on opposite sides with the ejection port array interposed therebetween. The first supply opening 22 and the second supply opening 32 are supplied with a liquid from a common flow path 38.

Ink flows in the individual flow paths are roughly categorized into (1) a first ink flow to drive the first energy generation elements 14 and perform refilling after ejection and (2) a second ink flow to drive the second energy generation elements 24 to form a circulation flow.

In a case where the first energy generation elements 14 are driven and the liquid is ejected from the ejection ports 11, the ink accompanying ejection is supplied from the first supply opening 22 and the second supply opening 32 as illustrated in FIG. 3D, and the ink flows into the pressure chambers from both the supply openings.

In a case where the second energy generation elements 24 are driven to form the circulation flow, the ink flows into the individual flow paths 23 through the first supply opening 22 located on the side of the connection flow path and flows to the outside through the second supply opening 32 which is not located on the side of the connection flow path. In this example, the circulation flows 27 indicated by the arrows are formed in the individual flow paths 23 by returning the ink flowing out from the second supply opening 32 to the first supply opening 22 and causing the ink to circulate. Note that a configuration in which the first supply opening 22 and the second supply opening 32 are shared inside the chip is illustrated in FIG. 3B. Also, a configuration in which the first supply opening 22 and the second supply opening 32 are connected to the individual flow paths and are shared outside the recording head is illustrated in FIG. 3C, and any of the configurations may be adopted.

### Principle of Pump

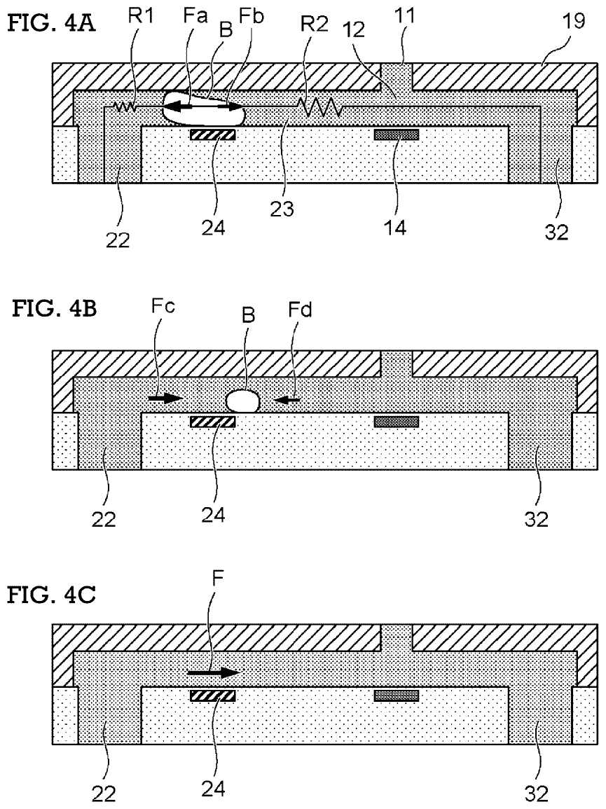

FIGS. 4A to 4C are diagrams for explaining a principle of generation of an ink circulation flow in the case where each second energy generation element (circulation heater) 24 which is an electrothermal conversion element is used. FIGS. 4A, 4B, and 4C are sectional views that illustrate a generation/growth process, a shrinkage process, and a process after defoaming of an air bubble B due to ink film boiling of the ink heated by the circulation heater 24, respectively, and that are similar to FIG. 3B. In FIG. 4A, the circulation heater 24 is located closer to the first supply opening 22 than the second supply opening 32. Therefore, a flowing resistance R1 between the circulation heater 24 and the first supply opening 22 is smaller than a flowing resistance R2 between the circulation heater 24 and the second supply opening 32. In FIG. 4A, equivalent circuits representing such flowing resistances R1 and R2 as electrical resistances are combined. The air bubble B generated due to ink film boiling grows on the side of the first supply opening 22 of the small flowing resistance R1 as in FIG. 4A due to a difference between the flowing resistances R1 and R2. Therefore, a flow Fa of the ink directed to the first supply opening 22 becomes greater than a flow Fb of the ink directed to a flowing-out flow path 15 inside each of the individual flow paths 23.

FIG. 4B is an explanatory diagram of an ink flow in a shrinkage process of the air bubble B. In the shrinkage process of the air bubble B, the ink flows in to compensate for the capacity corresponding to the amount of contraction. At that time, a flow Fc of the ink flowing in from the first supply opening 22 on the side of the small flowing resistance R1 is greater than a flow Fd of the ink flowing in from the second supply opening 32 on the side of the large flowing resistance R2 as in FIG. 4B. Furthermore, the defoaming position of the air bubble B deviates from the part above the circulation heater 24 on the side closer to the second supply opening 32.

FIG. 4C is an explanatory diagram illustrating the process after defoaming of the air bubble B. A circulation flow F of the ink directed from the first supply opening 22 to the second supply opening 32 is caused due to the relationship of Fc>Fd generated in FIG. 4B.

The magnitude of such a circulation flow F is affected by the ratio between the flowing resistances R1 and R2 and how large the air bubble B is. In particular, on the assumption of a case where the circulation heaters 24 which are electrothermal conversion elements are used as the second energy generation elements 24, for example, each second energy generation element 24 is preferably located closer to one of both end portions of each of the individual flow paths 23 than the first energy generation element. More specifically, it is preferable to set the flowing resistance ratio R1/R2 within a range of 0.05 to 0.40. It is possible to cause the circulation flow F to become a maximum value by setting the flowing resistance ratio R1/R2 within the range. It is important to increase the flow Fa of the ink directed to the first supply opening 22 illustrated in FIGS. 4A and 4B and to increase the flow Fc of the ink flowing in from the first supply opening 22 in regard to the circulation flow F. Therefore, it is effective to reduce the flowing resistance R1. Moreover, it is important to minimize the flow Fb of the ink directed to the flowing-out flow path 15 and to reduce the flow Fd of the ink flowing in from the second supply opening 32. Therefore, it is effective to increase the flowing resistance R2. As described above, it is important to reduce the flowing resistance R1 and to increase the flowing resistance R2, that is, to reduce the flowing resistance ratio R1/R2. Additionally, since the air bubble B with a large size, that is, a large air bubble volume leads to an increase in volume of a fluid removed from each of the individual flow paths 23, the circulation flow F increases.

Examples of a mechanism that increases the air bubble volume include:
An increase in size of the circulation heater 24
An increase in width or height inside the flow path 13 to thereby reduce the flowing resistance
A decrease in ink viscosity
An increase in head temperature
To double the driving pulse

The concentrated ink inside the ejection port 11 is sent out to the side of the second supply opening 32 by a part of the circulation flow F of the ink entering the ejection port 11, and a fresh ink is caused to flow into the ejection port 11 through the connection flow path 13 from the side of the first supply opening 22. It is possible to maintain the initial ink ejection state with influences of the concentrated ink curbed by causing the concentrated ink to be less likely to remain in the ejection port 11.

The circulation flow F is a transitional flow accompanying the growth process and the shrinkage process when the air bubble B is generated. Therefore, the inertial flow is attenuated with elapse of time after the defoaming of the air bubble B and is stopped after a specific period of time. Therefore, it is necessary to repeatedly drive a heat generation element of the circulation heater 24 in order to regularly generate the circulation flow F for a certain period of time. The driving cycle of the circulation heater 24 may be any cycle as long as it is possible to discharge the concentrated ink inside the ejection ports 11 and is not particularly limited. However, since the flow is a transitional flow accompanying the growth process and the shrinkage process when the air bubble B is generated, the effect decreases in a case where the driving is performed at a driving frequency that is as high as 100 kHz or the like in consideration of a cycle of 10 μs, which is a defoaming time from the generation of the air bubble. Therefore, it is preferable to drive the circulation heater 24 at a cycle of 100 Hz to about several tens of kHz, for example, and as the driving frequency is higher, the circulation flow F is further maintained, and the effect of discharging the concentrated ink further increases. However, on the other hand, it is necessary to consider a temperature rise of the ink due to heat generation accompanying the driving of the circulation heater 24. Therefore, it is necessary to appropriately set the number of times of driving of the circulation heater 24.

Note that it is conceivable that the second energy generation element that is in charge of the circulation has a lower driving energy than the ordinary driving energy to perform ejection driving. In other words, the circulation driving of the second energy generation element may be driving of weaker energy than that of the ejection driving by the first energy generation element. Even in a case where the driving energy of the second energy generation element is lowered, it is possible to perform adjustment with the size and the aspect ratio of the energy generation element in accordance with it.

### Recirculation Concentration

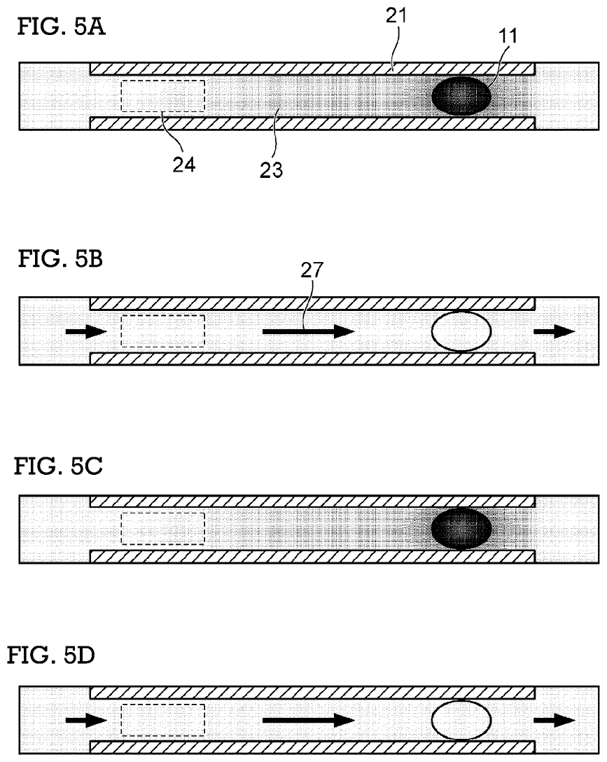

FIGS. 5A to 5D are diagrams for explaining how concentration accompanying the circulation flow of the ink by the second energy generation element is solved. A straight-type configuration in which an inlet and an outlet of the circulation flow in each of the individual flow paths are separated is illustrated, a portion where the ink has been concentrated is illustrated with a dark color, and the level of concentration is expressed by how dark/light the color is.

In FIGS. 5A to 5D, a state of temporary pause is illustrated in FIG. 5A. During the temporary pause, volatile components are evaporated from the ejection port portion, and the concentration of the ink progresses in the vicinity of the ejection port. A state achieved by causing the circulation flow by the second energy generation element thereafter is illustrated in FIG. 5B. The concentration in the vicinity of the ejection port is solved by the circulation flow. The ink concentrated in the vicinity of the ejection port is discharged from the outlet, and the concentration is solved in the entire individual flow paths. A state achieved by further temporarily pausing thereafter is illustrated in FIG. 5C. Similarly to FIG. 5A, the concentration of the ink progresses again in the vicinity of the ejection port. A state immediately after the circulation flow is further caused by the second energy generation element thereafter is illustrated in FIG. 5D. Similarly to FIG. 5B, the concentration in the vicinity of the ejection port is solved again, and the concentration is solved in the entire individual flow paths. As described above, the concentrated state is reset every time the temporary pause and the circulating operation are repeated in the straight type in which the inlet and the outlet of each of the individual flow path are separated.

As described above, it is possible to reset the concentrated state including the entire individual flow paths for each circulating operation in the straight type in which the inlet and the outlet of the circulation flow in the individual flow paths are separated, and influences of concentration are thus unlikely to occur in a continuously stable manner through the circulation. Therefore, there is a structural feature that ejection stability is less likely to decrease due to the concentrated ink.

### Ink

As described hitherto, it is possible to curb influences of the concentrated ink with a viscosity increased due to evaporation at the ejection ports by causing the ink circulation flow in the individual flow paths using the second energy generation elements. In other words, it is possible to satisfactorily maintain the ink ejection state and to thereby further reduce influences such as a change in ejection speed and the like, and the ejection is likely to be stabilized.

On the other hand, utilization of inks of different kinds of coloring materials, different amounts of solid content, and the like is assumed depending on applications of the liquid ejection head and the liquid ejection device with the head mounted thereon. In other words, as performance of the liquid ejection head, ejection stability at a high level can be preferably maintained regardless of what kind of ink is used. For example, utilization of an ink with a reduced water content in response to problems caused by water in the ink, such as curling (warpage) or cockling (wave-shaped wrinkles) of plain paper is conceivable. Since the concentration of solid content such as an organic solvent, a pigment, and a resin other than water is high in the ink with a reduced water content, a sudden increase in viscosity is likely to occur with evaporation of water, which is likely to lead to a decrease in ink ejection stability. The method of causing the circulation flow inside the pressure chamber as in the present disclosure is very effective for such an ink since it is possible to curb an increase in viscosity of the ink. In general, the solid content in the ink containing a large amount of solid content is 10 wt %. In other words, the present disclosure is preferably applied to the ink with the amount of solid content in the ink of at least 10 wt % (% by mass).

Furthermore, in regard to the temperature at which the head is operated, the head may be used at a temperature raised to a specific temperature by disposing a heater for the entire chip and controlling the heater. Since the ink viscosity varies depending on the temperature, the ink viscosity at the head operation temperature affects ejection stability.

In a case where the circulation flow is formed by the second energy generation elements, a value of the circulation flow rate can be several tens of mm/s to 1000 mm/s in terms of an instantaneous flow rate. An average flow rate in terms of a time width in several hundreds of microseconds order depends on a driving frequency of the circulation heaters. This is because in the case of the circulation heaters, the circulation flow is a transitional circulation flow that is attenuated with elapse of time and stops after a specific period of time. In a case where the second energy generation elements are driven at about 10 to 20 kHz, which is similar to the driving frequency (ejection frequency) of the first energy generation elements, the average flow rate can be several mm/s to 100 mm/s.

In a case where an ink with a high concentration of pigment, for example, an ink with such a concentration that leads to a viscosity of at least 3 cp and not more than 6 cP at the head operation temperature is used, an increase in ink viscosity is likely to progress at the ejection port portions in accordance with a non-ejection time (pause time). Therefore, the ejection speed is likely to change, which is likely to lead to a decrease in ejection stability. Therefore, it is necessary to perform ink circulation while the pause time is short, and it is necessary to solve the concentration by regularly performing ink circulation or frequently performing transitional ink circulation. In a case where the circulation heaters are used as the second energy generation elements, transitional ink circulation is achieved, and it is thus possible to contribute to the solution of the concentration at the ejection port portion by frequently performing the circulating operation.

On the other hand, although a change in ejection speed may occur in accordance with the non-ejection time (pause time) in a case where an ink with a low concentration of pigment, for example, an ink with such a concentration that leads to a viscosity of at least 1 cp and not more than 2 cP at the heat operation temperature is used, the influences thereof are relatively smaller than those of the ink with a high concentration. On the other hand, in a case where the pause time is long, an increase in ink viscosity progresses at the ejection port portion in accordance with a non-printing drive time (stopping time), for example. Therefore, it is necessary to perform recovery processing accompanying ink discarding such as a suctioning operation, a wiping operation, preliminary ejection in accordance with these operations when the operation is restarted after printing is not performed and is stopped for a specific period of time. In the case where the circulation heaters are used as the second energy generation elements, it is possible to contribute to the solution of the concentration at the ejection port portion without causing ink discarding by forming the circulation flow as a recovering operation. It is also possible to prevent ink discarding from occurring through the recovery processing including only the circulation operation depending on the stopping time. Alternatively, recovery processing of minimizing ink discarding can also be performed by partially combining a suctioning operation or the like to remove air bubbles inside the head, which is different from the solution of the concentration, while performing the circulating operation for recovery.

It is desirable to return the ink to an initial fresh ink as much as possible in order to curb the influences of the concentrated ink regardless of the concentration of the ink is high or low. Therefore, it is possible to obtain a better circulation effect as the influences of the recirculation concentration are smaller even in the case where the circulation heaters are used as the second energy generation elements. In other words, the effect can be preferably exhibited in the straight-type configuration.

### First Embodiment

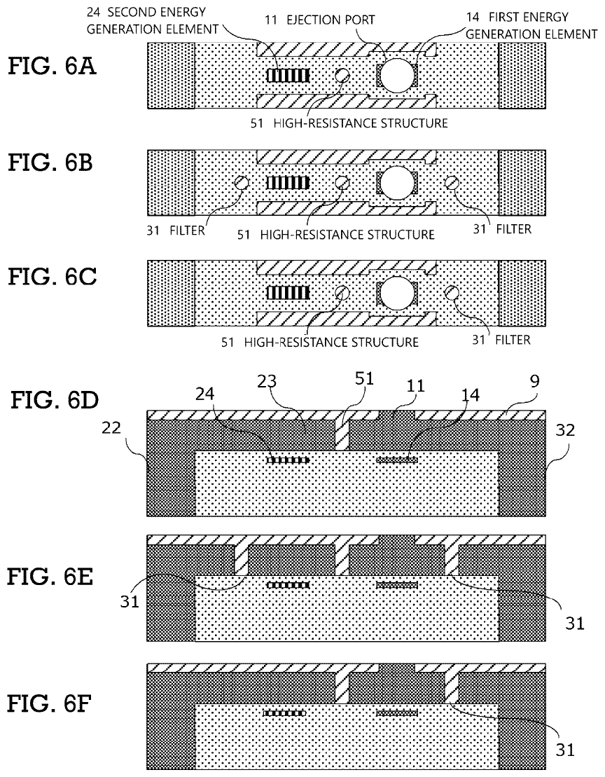

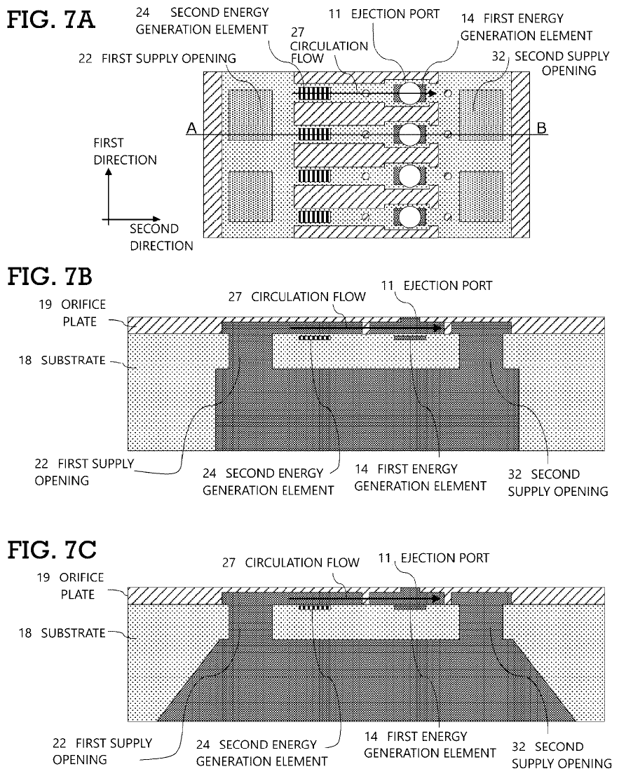

FIGS. 6A to 6F and FIGS. 7A to 7C are schematic views for explaining in detail the vicinity of an ejection port of a liquid ejection head that ejects a liquid such as an ink according to the first embodiment. FIGS. 6A to 6C are plan views of each of individual flow paths seen in a direction in which liquid droplets are ejected from the ejection port. FIGS. 6D to 6F are sectional views of FIGS. 6A to 6C.

In addition, FIG. 7A is an overall plan view of FIG. 6C. FIGS. 7B and 7C illustrate two examples of sectional views along A-B in FIG. 7A. Although FIGS. 7B and 7C illustrate the two examples because the shape on the rear side of a substrate changes depending on a kind of an etching method performed on the substrate, the section may have any of the shapes.

In FIGS. 6A to 6F and FIGS. 7A to 7C, ejection ports 11 that eject a liquid are formed in an orifice plate 19. First energy generation elements 14 are formed immediately below the ejection ports 11 in the substrate 18. Second energy generation elements 24 are similarly formed in the substrate 18 along with the first energy generation elements 14 to form a circulation flow 27 in the individual flow paths 23. A liquid is supplied from supply openings 22 and 32 to the individual flow paths 23 including the ejection ports 11. At this time, both ends of each of the individual flow paths are disposed at opposite positions with respect to a second direction perpendicularly intersecting a first direction that is a direction in which the ejection ports are aligned.

In a straight flow path as shown in FIGS. 6A to 6F and FIGS. 7A to 7C, a circulation flow caused by the second energy generation elements 24 being placed at asymmetric positions as described above is used. At this time, the side with a small flowing resistance of the end portions of the individual flow paths from the second energy generation elements 24 serves as an inlet (upstream), while the side with a large flowing resistance of the end portions of the individual flow paths from the second energy generation elements 24 serves as an outlet (downstream). Thus, it is preferable to set a small flowing resistance on the side of the inlets from the second energy generation elements 24 and to set a large flowing resistance on the side of the outlets from the second energy generation elements in terms of the circulation flow amount. However, if the flowing resistance on the side of the outlets from the second energy generation elements 24 is simply increased, the length of the individual flow paths increases, which is accompanied with increases in substrate size and head size. Therefore, it is preferable to set a large flowing resistance on the side of the outlets from the second energy generation element 24 while shortening the flow path length in terms of the circulation flow amount.

On the other hand, a flowing resistance on the side of the outlets from the first energy generation elements 14 in the flowing resistance on the side of the outlets from the second energy generation elements 24 is preferably small because the parts serve as main supply portion that performs refilling by the amount corresponding to the ejected liquid at the time of ejection. Therefore, it is preferable and important to set a large flowing resistance between the first energy generation elements 14 and the second energy generation elements 24 from the viewpoint of achieving both the circulation flow amount and the refilling property at the time of ejection. At this time, an effect that it is possible to reduce interference (crosstalk) between the first energy generation elements 14 and the second energy generation elements 24 is also obtained.

Accordingly, the present embodiment is characterized by including high-resistance structures 51 at the centers of the flow paths between the first energy generation elements 14 and the second energy generation elements 24 as illustrated in FIG. 6A. It is thus possible to secure the circulation flow amount by setting a small flowing resistance on the side of the second energy generation elements 24 and the inlets and setting a large flowing resistance on the side of the outlets from the second energy generation elements 24. Furthermore, it is also possible to secure the refilling property at the time of ejection by setting the large flowing resistance between the first energy generation elements 14 and the second energy generation elements 24 to thereby set a small flowing resistance on the side of the first energy generation elements 14 and the outlets. In this manner, it is possible to achieve both the circulation flow amount and the refilling property at the time of ejection by partially providing a region in which a large flowing resistance is set between the first energy generation elements 14 and the second energy generation elements 24. Here, it is possible to understand this as partially providing a region where the sectional area in the circulation direction is reduced. The high-resistance structures 51 are a kind of resistance structures that increase the flowing resistance between the first energy generation elements 14 and the second energy generation elements 24.

Note that although the high-resistance structures 51 at the centers of the flow paths in the present embodiment are illustrated as cylindrical structures, other columnar structures may be adopted from the viewpoint of increasing a large flowing resistance, and the high-resistance structures 51 may be a quadrangular prism structure or a triangular prism structure, for example. Furthermore, the high-resistance structures 51 may be columnar structures with a length elongated in the flow path direction like rounded rectangles when seen from the top, and a plurality of columnar structures may be provided in each high-resistance structure 51. However, it is possible to further increase the resistance in a state where the high-resistance structures 51 are provided than in a state where the high-resistance structures 51 are not provided and to thereby obtain the effect to some extent regardless of the sectional shape.

FIG. 6B is a modification in which filters 31 are provided on both sides of the individual flow paths. The filters 31 are used to prevent foreign matters contained in the ink and the supply paths from entering the individual flow paths. The filters 31 are disposed at portions connected to the common flow path. This is a counter measure against a concern that if foreign matters are mixed near the first energy generation element, ink ejection from the ejection ports may not occur or an image may be degraded in a printed object due to a failure in ejection. It is also possible to achieve both the circulation flow amount and the refilling property at the time of ejection in FIG. 6B as well similarly to FIG. 6A. In the example of FIG. 6B, the filters 31 are disposed on the side further upstream (the side close to the first supply opening 22) than the second energy generation elements 24 and the side further downstream (the side close to the second supply opening 32) than the first energy generation elements 14.

FIG. 6C is a modification in which the filter 31 is provided only on the side of the first energy generation element in each of the individual flow paths. This is achieved from the viewpoint of providing the filter structure for the main supply portion that performs refilling by the amount corresponding to the ejected liquid at the time of ejection. This is also achieved because the high-resistance structure is provided on the opposite side in each of the individual flow paths. Furthermore, the flowing resistance on the side of the inlets from the second energy generation elements decreases as compared with FIG. 6B since no filters are provided on the side. Also, the flowing resistance on the side of the outlets from the second energy generation elements increases since the filter remains on the side. Therefore, it is possible to state that FIG. 6C is further preferable than FIG. 6B from the viewpoint of the circulation flow amount.

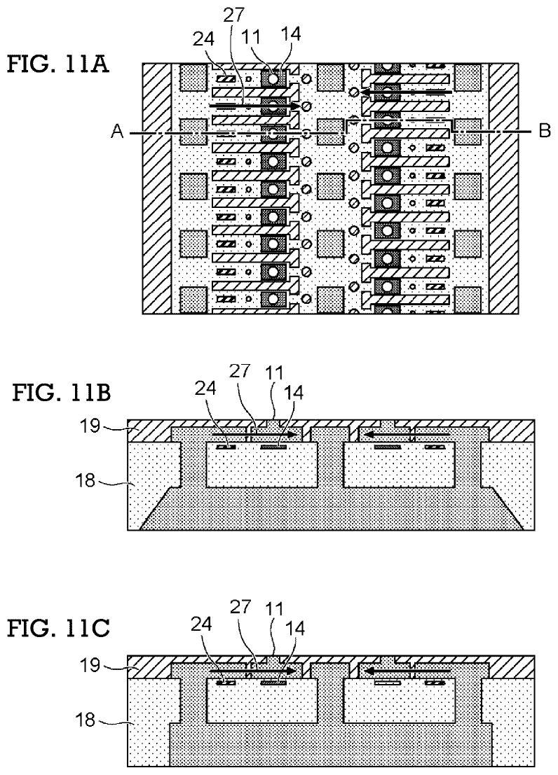

FIG. 7A illustrates an overall configuration in which a plurality of flow paths are formed using the flow path illustrated in FIG. 6C as an example. First supply openings 22 and second supply openings 32 are provided on the side of the inlets (upstream) in the individual flow paths and on the side of the outlets (downstream) in the individual flow paths, respectively. This configuration thus function as a liquid ejection head by forming a plurality of ejection ports. Although the same applies to FIGS. 6A and 6B and FIGS. 9A to 9D and FIGS. 10A to 10F, which will be described later, only one flow path is illustrated therein. Also, FIGS. 11A to 11C and the subsequent drawings illustrate the overall configuration using the flow path illustrated in FIG. 6C as an example.

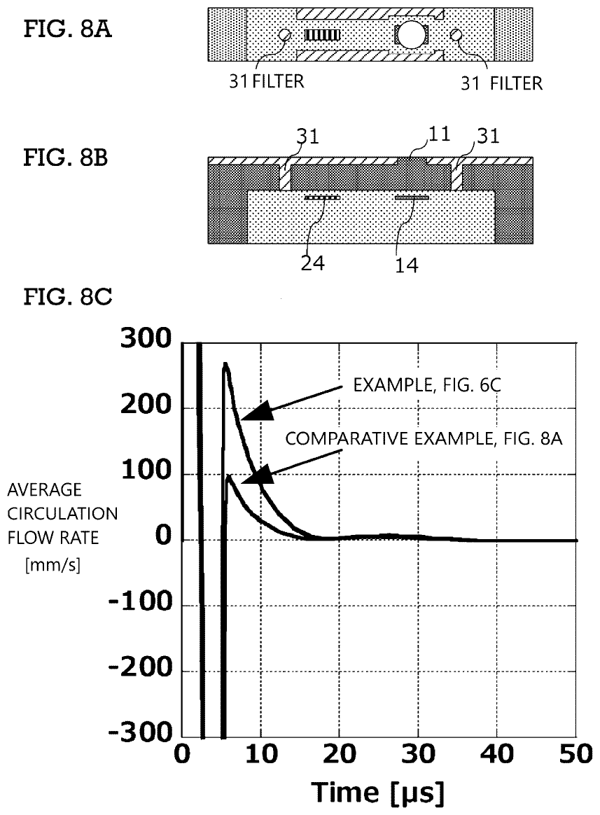

FIGS. 8A to 8C are diagrams illustrating a circulation flow amount in each flow path configuration. FIG. 8A is a plan view of each of the individual flow paths seen in a direction in which liquid droplets are ejected from the ejection port in a comparative example in which no high-resistance structures are included. FIG. 8B is a sectional view of FIG. 8A. FIG. 8C is a graph showing average circulation flow speeds from a simulation when the circulation heaters that are the second energy generation elements are driven once in regard to FIG. 8A illustrated in plan view as not having the high-resistance structures and FIG. 6C having the high-resistance structures according to the present embodiment. Here, since flow rate distribution in the sectional direction is present, average circulation flow rates that are circulation flow rates averaged by the sectional areas are shown. Note that the circulation flow amounts are obtained through integration in the horizontal axis direction in FIG. 8C.

It is possible to ascertain from FIG. 8C that the average circulation flow rate is higher and the circulation flow amount is similarly larger in the present embodiment including the high-resistance structures than in the comparative example. In the simulation, calculation is performed on the assumption that the flow path height is 24 μm, the pressure chamber width is 30 μm, the flow path width other than the pressure chamber width is 28 μm, the heater size of the circulation heaters that are second energy generation elements is 15 μm×15 μm, the flow path length is 115 μm, and the viscosity of the liquid to be circulated is 4 cp. Also, the circulation flow amount is increased by including the high-resistance structures in a similar manner in a case of other dimensions and conditions. It is possible to ascertain that the circulation flow amount is improved by including the high-resistance structures at the centers of the flow paths between the first energy generation elements and the second energy generation elements as described above.

### Driving Method in Embodiment: Toggle Driving

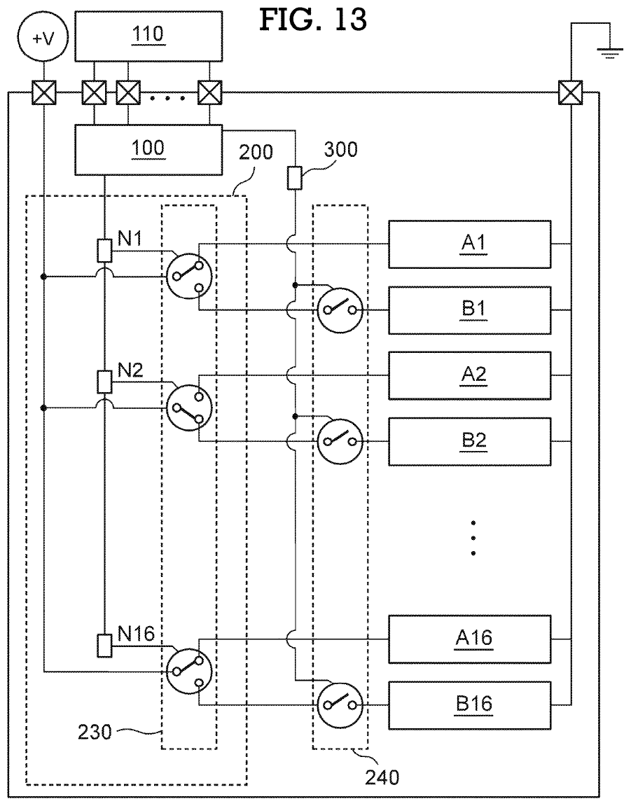

In the present embodiment, a selective drive circuit 200 as illustrated in FIG. 13 is formed on the substrate 18. A voltage source and a controller 110 are provided outside the substrate 18 and are connected to the selective drive circuit 200 on the substrate 18. An ON-ON drive circuit (a first switch that performs switching between ON and ON) 230 that turns on either the first energy generation elements (A1 to A16) or the second energy generation elements (B1 to B16) to drive them in response to a control signal at each address (N1 to N16 in the case of the present embodiment) received from a control data supply circuit 100 is included.

In other words, a switch configured to be able to perform exclusive switching such that only either the first energy generation elements or the second energy generation elements are brought into a state where they can be driven is included. With this switch, the second energy generation elements are always in a state where they cannot be driven in a state where the first energy generation elements can be driven, and on the contrary, the first energy generation elements are always in a state where they cannot be driven in a state where the second energy generation elements can be driven. Here, the control data supply circuit 100 controls a drive pulse for driving the first energy generation elements or the second energy generation elements and a period of time (intervals) for applying the drive pulse to each element.

Even when the ON-ON drive circuit 230 selects the side of the second energy generation elements, an ON-OFF drive circuit (a second switch that performs switching between ON and OFF) 240 of the second energy generation elements controls driving in response to a driving availability signal 300 of the second energy generation elements. In other words, the second energy generation elements are further controlled by the switch configured to be able to perform switching between the state where they can be driven and the state where they cannot be driven. Therefore, although the second energy generation elements are in a state where they can be driven in the case where the first energy generation elements cannot be driven, the second energy generation elements are actually driven only in a case where a drive signal (driving availability signal) for providing an instruction for driving to the second energy generation elements is received. In a case where there are no driving availability signals, the second energy generation elements are not driven even if the ON-ON drive circuit 230 has selected the side of the second energy generation elements. In other words, neither the first energy generation elements nor the second energy generation elements are driven at this time.

To summarize the foregoing, the present embodiment is configured such that the drive circuit to control driving of the first energy generation elements and the second energy generation elements includes the first switch configured to be able to perform exclusive switching such that only either the first energy generation elements or the second energy generation elements can be driven and the second switch configured to be able to perform switching the second energy generation elements between the state where they can be driven and the state where they cannot be driven and the driving of the first energy generation elements and the second energy generation elements is controlled under the following conditions by using the drive circuit.
Conditions: The second energy generation elements are not driven in the case where the first energy generation elements are driven, and the second energy generation elements are driven when the drive signal for giving an instruction for driving to the second energy generation elements is received in a case where the first energy generation elements are not driven.

Furthermore, the ON-OFF drive circuit (the second switch) is preferably provided on the side closer to the second energy generation elements with respect to the ON-ON drive circuit (the first switch), that is, on the electrically downstream side with respect to the second energy generation elements. Also, the driving of the plurality of second energy generation elements is preferably controlled using a common drive signal.

In such control, the controller 110 and the control data supply circuit 100 can be considered as a driving control portion to control the driving of the first energy generation elements and the second energy generation elements.

Separately from the toggle driving described hitherto, driving control may be performed such that the driving of the first energy generation elements and the driving of the second energy generation elements are individually controlled.

### Second Embodiment

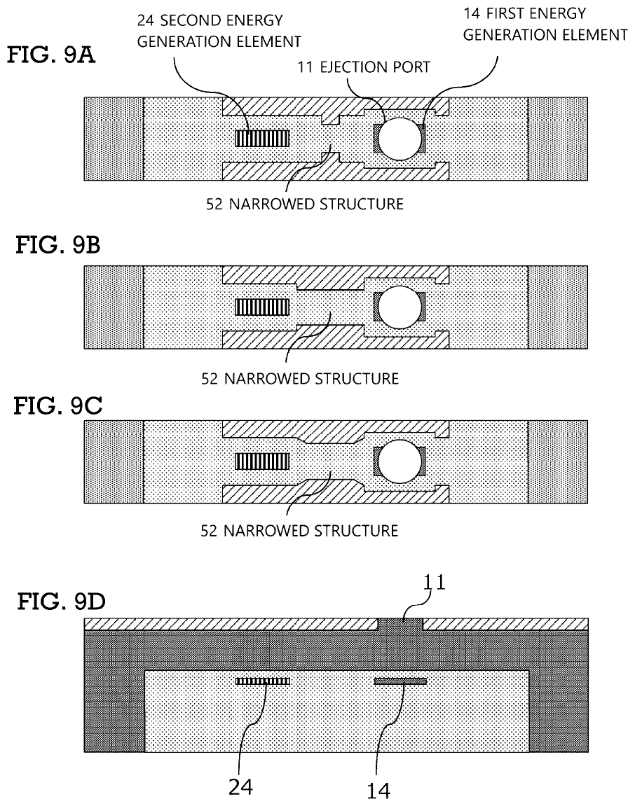

FIGS. 9A to 9D are schematic views for explaining the vicinity of an ejection port of a liquid ejection head that ejects a liquid such as an ink according to a second embodiment in detail. FIGS. 9A to 9C are plan views of each of individual flow paths seen in a direction in which liquid droplets are ejected from the ejection port. FIG. 9D is a sectional view common to FIGS. 9A to 9C. Note that in addition to the configuration of the present embodiment, it is also possible to dispose filters on both sides of the individual flow paths or only on the side of the first energy generation elements. In that case, the filters can be disposed at positions similar to those in FIGS. 6B and 6C.

The present embodiment is different from the first embodiment in that narrowed structures 52 with a narrowed flow path width are provided between first energy generation elements 14 and second energy generation elements 24. In the present embodiment, FIG. 9A illustrates an example in which the narrowed structures 52 are provided at portions of the flow paths between the first energy generation elements 14 and the second energy generation elements 24. Also, FIG. 9B illustrates a modification in which the narrowed structures 52 are provided at longer portions of the flow paths between the first energy generation elements 14 and the second energy generation elements 24. Furthermore, FIG. 9C illustrates a modification in which the narrowed structures 52 with a flow path width that is continuously narrowed instead of being non-continuously narrowed are provided. In other words, the flow path width is changed between the part with the narrowed flow path width and the part with the wide flow width in FIG. 9B, while the flow path width is continuously changed in FIG. 9C. The narrowed structures 52 are a kind of resistance structures that increase a flowing resistance between the first energy generation elements 14 and the second energy generation elements 24.

As an advantage achieved by adopting this configuration, it is possible to achieve both the circulation flow amount and the refilling property at the time of ejection while shortening the flow path by increasing the flowing resistance between the first energy generation elements 14 and the second energy generation elements 24 similarly to the first embodiment. Furthermore, since the narrowed structures 52 integrated with flow path walls forming the individual flow paths are provided instead of forming the high-resistance structures 51 as single bodies as in the first embodiment to increase the flowing resistance, adhesiveness with the substrate is increased, and the structures become less likely to peel off.

Here, the length by which the narrowed structures 52 are provided in the circulation direction is preferably obtained by excluding the lengths of the first energy generation elements 14 and the second energy generation elements 24. This is because a large difference between left and right flowing resistances with respect to the first energy generation elements 14 and approaching the flow path walls to the first energy generation elements themselves or overlapping therebetween may affect ejection. In regard to the second energy generation elements 24, this is because overlapping of the flow path walls with the second energy generation elements themselves may affect foaming or may decrease the foaming size of the second energy generation elements 24, which may lead to a decrease in circulation flow amount.

### Third Embodiment

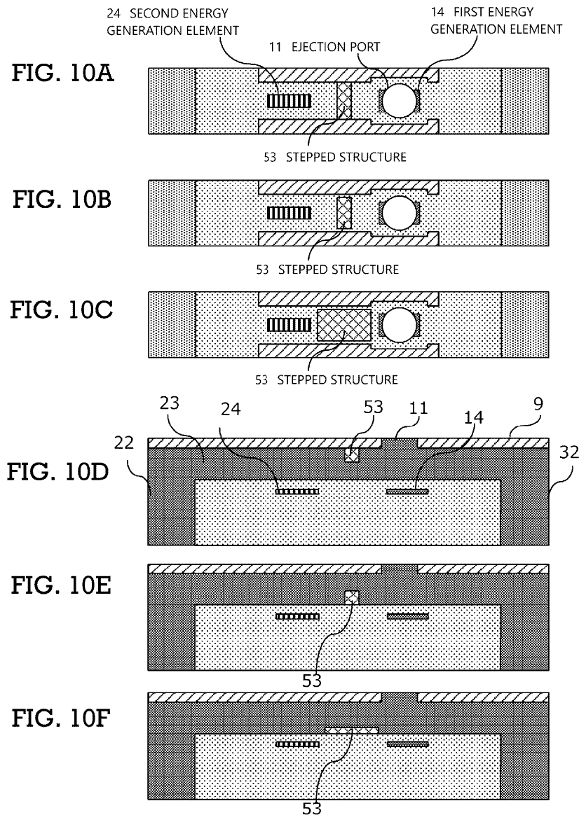

FIGS. 10A to 10F are schematic views for explaining the vicinity of an ejection port of a liquid ejection head that ejects a liquid such as an ink according to a third embodiment in detail. FIGS. 10A to 10C are plan views of each of individual flow paths seen in a direction in which liquid droplets are ejected from the ejection port. FIGS. 10D to 10F are sectional views of FIGS. 10A to 10C, respectively. Note that in addition to the configuration of the present embodiment, it is also possible to dispose filters on both sides of the individual flow paths or only on the side of the first energy generation elements. In that case, the filters can be disposed at positions similar to those in FIGS. 6B and 6C.

The present embodiment is different from the first embodiment in that stepped structures 53 with a narrowed flow path height are provided between first energy generation elements 14 and second energy generation elements 24. In the present embodiment, FIG. 10A illustrates an example in which the stepped structures 53 are provided at upper portions of portions of flow paths between the first energy generation elements 14 and the second energy generation elements 24. Also, FIG. 10B illustrates a modification in which the stepped structures 53 are provided at lower portions of portions of the flow paths. Furthermore, FIG. 10C illustrates a modification in which the stepped structures 53 are provided at lower portions of longer portions of the flow paths between the first energy generation elements 14 and the second energy generation elements 24. The stepped structures 53 are a kind of resistance structures that increase the flowing resistance between the first energy generation elements 14 and the second energy generation elements 24.

Here, in the case of the stepped structures 53 at the upper portions of the flow paths, the stepped structures 53 may be the same members as an orifice plate 9 where the ejection ports are formed. Although the stepped structures 53 are illustrated as extending entirely in the flow width direction in the drawing, the stepped structures 53 may be provided at a portion in the flow path width direction. Furthermore, in the case of the stepped structures 53 at the lower portions of the flow paths, the stepped structures 53 may be the same members as the orifice plate 9 or may be partial structures such as circuits formed in the substrate. Although the stepped structures 53 at the lower portions are also illustrated at a portion in the flow path width direction, the stepped structure may extend entirely in the flow path width direction. Here, the stepped structures are illustrated at a part in the flow path width direction from the viewpoint of adhesiveness depending on the flow path walls of the individual flow paths extending above or below the steps or a difference between materials of the flow path walls of the individual flow paths and the substrate outermost surface. Note that in the present disclosure, the direction directed from the first energy generation elements 14 to the ejection ports 11 in the individual flow paths 23 is defined as the height direction, and the direction perpendicularly intersecting the height direction and the extending direction of the individual flow paths 23 is defined as the width direction.

As an advantage achieved by adopting this configuration, it is possible to achieve both the circulation flow amount and the refilling property at the time of ejection while shortening the flow path by increasing the flowing resistance between the first energy generation elements 14 and the second energy generation elements 24 similarly to the first embodiment. Since the stepped structures 53 are formed at the upper portions or the lower portions in order to increase the flowing resistance, adhesiveness with the substrate is not likely to become an issue. For example, in the case where the stepped structures 53 at the upper portions are integrated as the same member as the orifice plate 9, there is no need to consider adhesiveness with the substrate. Also, in the case where the stepped structures 53 at the lower portions are partial structures formed in the substrate, there is similarly no need to consider adhesiveness with the substrate.

Here, the length by which the stepped structures 53 are provided in the circulation direction is preferably obtained by excluding the lengths of the first energy generation elements 14 and the second energy generation elements 24 as described above for the narrowed structures 52. Furthermore, this is also because in the case where the stepped structures 53 at the lower portions are partial structures such as circuits formed in the substrate, the first energy generation elements 14 and the second energy generation elements 24 are also similarly formed.

### Fourth Embodiment

FIGS. 11A to 11C are schematic views for explaining the vicinity of an ejection port of a liquid ejection head that ejects a liquid such as an ink according to a fourth embodiment in detail. FIG. 11A is a plan view seen in a direction in which liquid droplets are ejected from the ejection ports. FIGS. 11B and 11C illustrate two examples of sections along A-B in FIG. 11A, similarly to FIGS. 7B and 7C.

The present embodiment is different from the second embodiment in that ejection port arrays are double arrays by providing three supply opening arrays and each ejection port array is located on the side close to the supply opening array at the center. In other words, the ejection port arrays are formed on both sides of the alignment direction of the plurality of supply openings. The ejection port arrays are alignment of ejection ports 11 included in unit arrays in which a plurality of individual ejection units are aligned. In the present embodiment, a first unit array and a second unit array are aligned in parallel to each other. Here, the opening array at the center shared by the first unit array and the second unit array is defined as a second opening array in which the second openings are aligned. Also, the opening arrays at end portions that the first unit array and the second unit array have are defined as first opening arrays in which the first openings are aligned.

As an advantage of adopting this configuration, it is possible to double the ejection port array from one array to two arrays by increasing the supply openings by one array from two arrays to three arrays. It is also possible to dispose the two ejection port arrays with deviation of pitches as in the drawing. Also, a configuration that does not require a wiring region between the openings in the supply opening array at the center is possible, and a degree of freedom in the size of the openings and resolution at the supply opening array at the center is high. In this manner, it is possible to increase the speed of refilling for the nozzles and to easily address high productivity.

Note that although the three supply opening arrays are at the same positions in the inter-nozzle direction in the present embodiment, the three arrays may be located with deviation in accordance with the nozzle positions or wiring arrangement between openings in each array. The same applies to the following embodiment.

### Fifth Embodiment

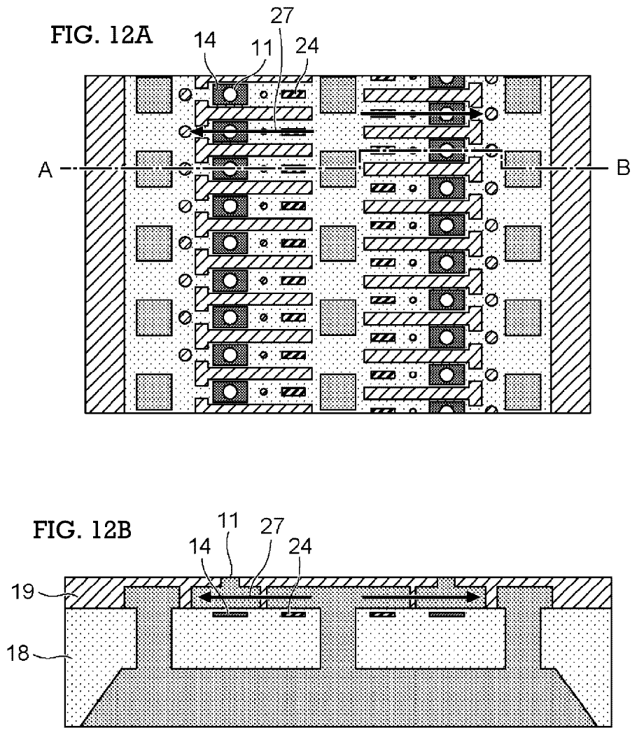

FIGS. 12A and 12B are schematic views for explaining the vicinity of an ejection port of a liquid ejection head that ejects a liquid such as an ink according to a fifth embodiment in detail. FIG. 12A is a plan view seen in a direction in which liquid droplets are ejected from the ejection ports. FIG. 12B is a sectional view along A-B in FIG. 12A.

The present embodiment is different from the third embodiment in that a direction of a circulation flow is inverted by ejection port arrays being located on the side close to supply opening arrays on both sides and by second energy generation elements 24 being located on a side close to a supply opening array at the center.

As an advantage of adopting the present configuration, the ink concentrated in the vicinity of the ejection ports is branched into and discharged from the supply opening arrays on both sides, and influences of the concentrated ink in response to ejection or the like when the ink flows into the individual flow paths again are curbed. Further, influences of interference due to meniscus vibration accompanying ejection from each ejection port are curbed since the ejection port arrays are disposed to be spaced apart from each other.

As described first, the object of the present disclosure is to provide a liquid ejection head capable of maintaining desired circulation efficiency and maintaining a circulation flow amount while further reducing the sizes of the head and the recording device by shortening the circulation flow path and reducing the substrate size. Therefore, the configuration including the plurality of individual ejection units that include the ejection ports, the pressure chambers, the first energy generation elements provided in the pressure chambers, the individual flow paths that communicate with the pressure chambers, and the second energy generation elements that are provided in the individual flow paths is adopted. In the individual ejection units, the direction in which the ejection port arrays are aligned and the extending direction of the individual flow paths including the first energy generation elements and the second energy generation elements intersect one another, and the flowing resistance or the flowing path sectional area increases or decreases between the first energy generation elements and the second energy generation elements. Specifically, the flowing resistance of one of both sides of the second energy generation elements is increased by providing the high-resistance structures, the narrowed structures, the stepped structures, or the like in the individual flow paths instead of elongating the flow paths. It is thus possible to provide a liquid ejection head capable of enhancing circulation efficiency and securing the circulation flow amount without elongating the circulation flow paths.

According to the present disclosure, it is possible to provide a liquid ejection head capable of exhibiting desired circulation efficiency and maintaining the circulation flow amount while shortening the circulation flow path and reducing the substrate size.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145433, filed Aug. 27, 2024, and, Japanese Patent Application No. 2025-083793, filed May 20, 2025 which are hereby incorporated by reference herein in their entirety.

What is claimed is:

1. A liquid ejection head comprising:
individual ejection units that include ejection ports that eject a liquid, pressure chambers that communicate with the ejection ports, first energy generation elements that are provided in the pressure chambers and generate heat energy for ejecting the liquid from the ejection ports, individual flow paths that communicate with the pressure chambers, and second energy generation elements that are provided in the individual flow paths and generate heat energy; and
a common flow path configured to supply the liquid to the individual flow paths of the plurality of individual ejection units, wherein
the plurality of ejection ports included in the plurality of individual ejection units form an ejection port array,
the first energy generation elements and the second energy generation elements are disposed in a direction intersecting the ejection port array in the individual flow paths of the individual ejection units,
the individual flow paths extend in a direction intersecting the ejection port array such that both end portions thereof are located with the ejection port array interposed therebetween, and
the individual flow paths are provided with resistance structures that increase a flow resistance between the first energy generation elements and the second energy generation elements.

2. The liquid ejection head according to claim 1, wherein
the second energy generation elements are not driven in a case where the first energy generation elements are driven, and
the second energy generation elements are driven when a drive signal to provide an instruction for driving to the second energy generation elements is received in a case where the first energy generation elements are not driven.

3. The liquid ejection head according to claim 2, further comprising:
a drive control unit configured to control driving of the first energy generation elements and the second energy generation elements.

4. The liquid ejection head according to claim 1, wherein driving of the first energy generation elements and driving of the second energy generation elements are individually controlled.

5. The liquid ejection head according to claim 1, wherein the resistance structures are columnar structures provided at centers of the individual flow paths.

6. The liquid ejection head according to claim 1, wherein the resistance structures are structures in which sectional areas of the individual flow paths are narrowed between the first energy generation elements and the second energy generation elements.

7. The liquid ejection head according to claim 6, wherein when a direction from the first energy generation elements to the ejection ports in the individual flow paths is defined as a height direction, and a direction perpendicularly intersecting the height direction and an extending direction of the individual flow paths is defined as a width direction, the resistance structures are narrowed structures that are provided in the width direction of the individual flow paths and have narrowed flow path widths.

8. The liquid ejection head according to claim 7, wherein in the narrowed structures, the flow path widths successively change between parts with the narrowed flow path widths and parts with the wide flow path widths.

9. The liquid ejection head according to claim 6, wherein the resistance structures are stepped structures in which the individual flow paths are narrowed in a height direction when a direction from the first energy generation elements to the ejection ports in the individual flow paths is defined as the height direction.

10. The liquid ejection head according to claim 9, wherein the stepped structures are provided on a side of the first energy generation elements in the height direction and are configured as a part of a substrate on which the first energy generation elements and the second energy generation elements are formed.

11. The liquid ejection head according to claim 6, wherein the resistance structures are provided in regions between the first energy generation elements and the second energy generation elements in the individual flow paths.

12. The liquid ejection head according to claim 9, wherein the stepped structures are provided at parts of the individual flow paths in the width direction.

13. The liquid ejection head according to claim 1, wherein
the individual flow paths are connected, at both end portions thereof, to the common flow path, and
filters are disposed at portions of the both end portions connected to the common flow path.

14. The liquid ejection head according to claim 1, wherein
the individual flow paths are connected, at both end portions thereof, to the common flow path, and
filters are disposed on a side of the first energy generation elements from among both the end portions of the individual flow paths.

15. The liquid ejection head according to claim 1, wherein the plurality of individual flow paths included in the plurality of individual ejection units and the common flow path are connected via openings.

16. The liquid ejection head according to claim 1, wherein
one end and the other end of each of the individual flow paths are connected to the common flow path via a first opening and a second opening, respectively, and
the plurality of first openings and second openings included in the plurality of individual ejection units are aligned with an ejection port array that is an array of the ejection ports included in the plurality of individual ejection units.

17. The liquid ejection head according to claim 1, wherein
one end and the other end of each of the individual flow paths are connected to the common flow path via first openings and second openings, respectively,
the plurality of individual ejection units are aligned in a direction perpendicularly intersecting an extending direction of the individual flow paths to configure unit arrays, and a first unit array and a second unit array are aligned in parallel to each other,
the individual flow paths included in the first unit array and the individual flow paths included in the second unit array share the second openings, and the plurality of second openings shared are aligned in the direction perpendicularly intersecting the extending direction of the individual flow paths to form second opening arrays, and
the first openings included in the first unit array and the first openings included in the second unit array are aligned in the direction perpendicularly intersecting the extending direction of the individual flow paths to form a plurality of first opening arrays.

18. The liquid ejection head according to claim 17, wherein in each of the plurality of individual flow paths, the first energy generation element is disposed on a side close to the second opening.

19. The liquid ejection head according to claim 1, wherein
the second energy generation elements perform circulation driving of circulating the liquid in the individual flow paths, and
the first energy generation elements perform ejection driving of ejecting the liquid from the ejection ports.

20. The liquid ejection head according to claim 19, wherein the circulation driving is driving requiring less energy than the ejection driving.
